(19) United States
(12) Patent Application Publication
(10) Pub. No.: US 2006/0239247 A1
(43) Pub. Date: Oct. 26, 2006

(54) Method and session initiation protocol (SIP) server with end-point capabilities check

(76) Inventor: Peter Postmus, Pierrefonds (CA)

Correspondence Address: Alex Nicolaescu;Ericsson Canada Inc., Patent Department, 8400 Decarie Blvd., Town Mount Royal, QC, H4P 2N2, CA

(21) Appl. No.: 11/114,155

(22) Filed: Apr. 26, 2005

(51) Int. Cl. H04L 12/66

(52) U.S. Cl. 370/352

(57) ABSTRACT

A method and Session Initiation Protocol (SIP) application server, the server comprising a SIP container supporting SIP communications and a SIP service running on the SIP server. When an SIP message is received at a SIP application server, the SIP container detects the message is destined to the local SIP service and determines which end-point capabilities are included in the SIP message, the end-point capabilities being, for example, indicative of the requirements for the proper processing of the message. The SIP container further determines whether or not end-point capabilities of the SIP service match the ones included in the SIP message, and upon determining that a match exist, invokes the SIP service and relays the message to the service. Otherwise, if a match is not detected, the SIP container does not invoke the SIP service, but rather issues an error message, or further relays the SIP message to another destination.

### BACKGROUND OF THE INVENTION

1. Field of the Invention

The present invention relates to a method and system for verifying end-point capabilities information.

2. Description of the Related Art

The Session Initiation Protocol (SIP) is an Internet Engineering Task Force (IETF) standard protocol that allows for the establishment of interactive user sessions involving multimedia elements such as video, voice, chat, gaming, and virtual reality. Like the Hyper Text Transfer Protocol (HTTP) or the Simple Mail Transfer Protocol (SMTP), SIP works in the application layer of the Open Systems Interconnection (OSI) communications model and can establish multimedia sessions or Internet telephony calls, modify, or terminate them. The protocol can also invite participants to unicast or multicast sessions that do not necessarily involve the initiator. Because SIP supports name mapping and redirection services, it makes possible for users to initiate and receive communications and services from any location, and for networks to identify the users wherever they are.

SIP is a request-response protocol, dealing with requests from clients and responses from servers. Participants are typically identified by SIP Uniform Resource Identifiers (URIs). Requests can be sent through any transport protocol, such as the User Datagram Protocol (UDP), the Simple Control Transport Protocol (SCTP), or Transfer Control Protocol (TCP). SIP can determine the end system to be used for the session, the communication media and media parameters, and the called party's desire to engage in the communication. Once these are assured, SIP establishes call parameters at either end of the communication, and handles call transfer and termination. SIP is specified in IETF's Request for Comments [RFC] 3261, which is herein included by reference.

SIP services are typically implemented via SIP-based application servers. A SIP application server is a server of the SIP-based distributed network that provides business logic for one or more application programs that enable the provision of SIP services. Examples of SIP services that may be provided to SIP users are: SIP conferencing service, SIP presence service, Push-To-Talk, SIP Session Forwarding, and Messaging Server.

Telecommunications equipment vendors developed SIP-based application servers that are currently reaching the market, as SIP services begin to be commercially exploited. For example, Telefonaktiebolaget LM Ericsson Inc (hereinafter called Ericsson), a telecommunications manufacturer, developed a SIP-based application server including a SIP Servlet Application Programming Interface (API), called SSA, based on JAVA™ programming running on top of a PC server or other platforms, such as for example Linux. The SSA offers an API that service developers can use to easily develop new SIP services, also called SIP applications. SSA is based on the Hyper Text Transfer Protocol (HTTP) servlet mechanism. The methods available in SSA are implemented in a SIP engine, also called the SIP container. The main purpose of SSA is to offer an abstraction from the SIP protocol. Ericsson included the SIP container in the Ericsson's Application Server (E-AS) as well as in Ericsson's Service Development Studio (SDS) package. Such an application server is a 3GPP (3^{rd} Generation Partnership Project) defined SIP application server, which acts as a central node in the IP Multimedia System (IPMM) architecture for enabling SIP-based applications. It combines a SIP container implementing the SSA methods and a full computer server. Ericsson's SDS is a Design and an Execution Environment where SIP applications for the Ericsson application server can be designed, deployed, executed and tested.

The telecommunications industry recognises that according to the 3^{rd} Generation Partnership Project (3GPP), the interface between the above-mentioned type of application server and the SIP core network is based on the ISC interface (IP Multimedia Subsystem (IMS) Service Control interface). However, at the present time, ISC is identical to SIP and therefore all statements made herein with respect to the SIP protocol, including in the claims, should be understood as referring equally to ISC.

IETF also defined so-called SIP option tags in RFC 3261, which is also herein included by reference. These option tags indicate capabilities of the SIP end-points (e.g. User Equipment (UE), application servers, etc) of a SIP session. Although the terminology of SIP “end-points” is used throughout the present specification, it is to be understood that the so-called end-points refer to and encompass any node in a route followed by a SIP message, which may not only include the sender and the receiver of the SIP message, but also any intermediate node, such as for example a SIP-based application server or proxy server, which may be configured to perform processing on the said SIP message. The RFC 3261 describes a mechanism in which, during a SIP session, SIP end-points can request from other end-points the capabilities they support, or advertise their own capabilities, or require from the recipient end-point the support of specific capabilities to make the service provision successful. For example, the following SIP message headers of various SIP messages (e.g. SIP INVITE message, SIP OPTION message, etc) are used for exchanging such option tag information: “Require”, “Supported”, “Proxy-Required”, and “Unsupported”. A SIP option tag is a string of characters associated with a particular SIP option (i.e., an extension), and identifies the option to SIP end-points.

Reference is now made to FIG. 1.a (Prior Art) that shows a list 100 of exemplary various SIP option tags 102, along with their short descriptions 104. It is to be noted that other option tags may also exist. Each such option tag may be included in a header of a SIP message like a SIP INVITE message, alone or along with one or more other option tags. For example, a SIP end-point may include in a “supported” header of a SIP INVITE message the following option tag value:
Option_tag value=“privacy”
which indicates to the receiving SIP end-point that the sender supports the privacy mechanism capability.

In many SIP implementations, a service running on a given SIP application server can act as an end-point and respond to a SIP request that it receives, or can initiate a SIP request by itself.

On the other hand, besides the option tags, IETF is also currently defining another type of end-point capability through the so-called SIP feature tags which are indicative of SIP caller/callee preferences and capabilities. Caller preferences are used, for example, to route a SIP request to the proper terminal of a given recipient (in SIP, a terminal is called User Equipment, i.e. UE), among possibly a plurality of terminals of the recipient, which supports capabilities indicated in the specific SIP message headers.

Callee preferences are used to advertise what capabilities are supported by a given UE (User Equipment) or required from a given UE to establish a SIP communication. The UE may advertise its own capabilities through the use of SIP feature tags included, for example, using a SIP message's “Contact” header employed during a SIP registration process. A given UE can also find out the feature tags supported by another UE by sending a SIP OPTIONS request to the SIP server. It may include a SIP “Contact” header with its own feature tags as well, so that each UE involved in a SIP session can learn about the other session participant's supported, or required, features. For example, when a caller requests a new SIP session to be established with a callee identified by a URI and having a plurality of UE terminals, feature tags included in the SIP request message insure that the SIP session is established with the UE that best corresponds to the tags required by the caller. In general, caller preferences describe how a SIP request can be best routed to a UE that supports certain feature tags. Feature tags can be included in an “Accept-Contact”, “Reject-Contact” and/or “Request-Disposition” header of various SIP messages, such as for example in SIP INVITE request messages, SIP OPTION request messages, etc, to ensure that the request message is routed to a terminal that registered with, or without, the network with that specific feature tag.

Reference is now made to FIG. 1.b (Prior Art) that shows a preliminary list 150 of various exemplary SIP feature tags 152, along with their short descriptions 154, although it is to be noted that other feature tags may exist. For example, a SIP end-point may include in a “Contact” header of a SIP INVTE message the following feature tag value:
Feature_tag value=“sip.audio”
which indicates to the receiving SIP end-point that the sender's device supports audio as a streaming media. It is also possible for other types of feature tags, such as for example proprietary feature tags, to be also included in a SIP message header.

However, SIP services are developed by various application developers with different degrees of knowledge and programming experience. Due to this discrepancy in the developers' skills, it was noticed that not all new SIP services are developed with the ability of managing SIP option tags and feature appropriately, and that some SIP services do not support SIP option tags or feature tags at all. It is easy for a service developer to forget to include this functionality when programming a new SIP service. Thus, it may happen that a service cannot appropriately respond to an incoming SIP message. For example, a problem arises when an incoming SIP message requires the support of a particular option or feature tag from the recipient end-point, and when this end-point is not configured for providing such support. In such circumstances, the recipient end-point cannot properly treat the incoming message to provide a meaningful response. Most often, when this occurs, the receiving end-point provides no answer or a faulty answer to such SIP messages, and in both cases this may escalate into a drop of the SIP communication session.

Although there is no prior art solution as the one proposed hereinafter for solving the above-mentioned deficiencies, the International Patent Application Publication number WO 01/46822 bears some relation with the present invention. In this publication, there is taught an API for SIP servlets. This API sets forth critical functionality required for servlets in order to handle messages that comply with SIP. The servlets implement telephone service logic, such as for example call forwarding, call screening and mobility service and may be resident on a SIP proxy server. A servlet manager is also resident on the SIP server and is responsible for receiving messages and determining which of the service should process the incoming messages. In this publication, the servlet manager is solely responsible for distributing incoming SIP messages to the proper SIP servlet and therefore, nothing in this publication suggest any kind of option or feature tags management.

It would therefore be advantageous to offer a higher level of abstraction to the service developer when programming a new SIP service, wherein such problems would be avoided. Accordingly, it should be readily appreciated that in order to overcome the deficiencies and shortcomings of the existing solutions, it would be advantageous to have a method and extended SIP engine/container for selectively transmitting an incoming SIP message to a SIP service end-point only when the service end-point match the SIP option tags and/or feature tags of the SIP message, herein designated as end-point capabilities.

The present invention provides such a method and system.

### SUMMARY OF THE INVENTION

In one aspect, the present invention is a method for processing an incoming Session Initiation Protocol (SIP) message, the method comprising the steps of:

a. receiving the incoming SIP message at a SIP application server, the incoming SIP message being destined to a SIP service;

b. detecting that the SIP service resides on the SIP application server;

c. determining end-point capabilities included in the incoming SIP message;

d. determining whether or not the end-point capabilities included in the incoming SIP message match end-point capabilities of the SIP service; and

e. upon determining that the end-point capabilities included in the incoming SIP message match the end-point capabilities of the SIP service, invoking the SIP service.

In another aspect, the present invention is a Session Initiation Protocol (SIP) application server comprising:

a SIP container supporting SIP communications; and

a SIP service running on the SIP server;

wherein when an incoming SIP message is received at a SIP application server, the SIP container detects that the message is destined to the SIP service, determines end-point capabilities included in the incoming SIP message, further determines whether or not the end-point capabilities included in the incoming SIP message match end-point capabilities of the SIP service, and upon determining that the end-point capabilities included in the incoming SIP message match the end-point capabilities of the SIP service, invokes the SIP service.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1.a (Prior Art) shows a list of various SIP option tags that may be included in SIP message headers;

FIG. 1.b (Prior Art) shows a list of various SIP feature tags that may be included in SIP message headers;

FIG. 2 is an exemplary high-level block diagram of a SIP application server according to the preferred embodiment of the present invention;

FIG. 3 is an exemplary representation of a SIP INVITE request comprising a SIP option tag included in “Supported” header as well as in a “Required” header according to the preferred embodiment of the present invention; and

FIG. 4 is an exemplary flowchart diagram of a method according to the preferred embodiment of the present invention.

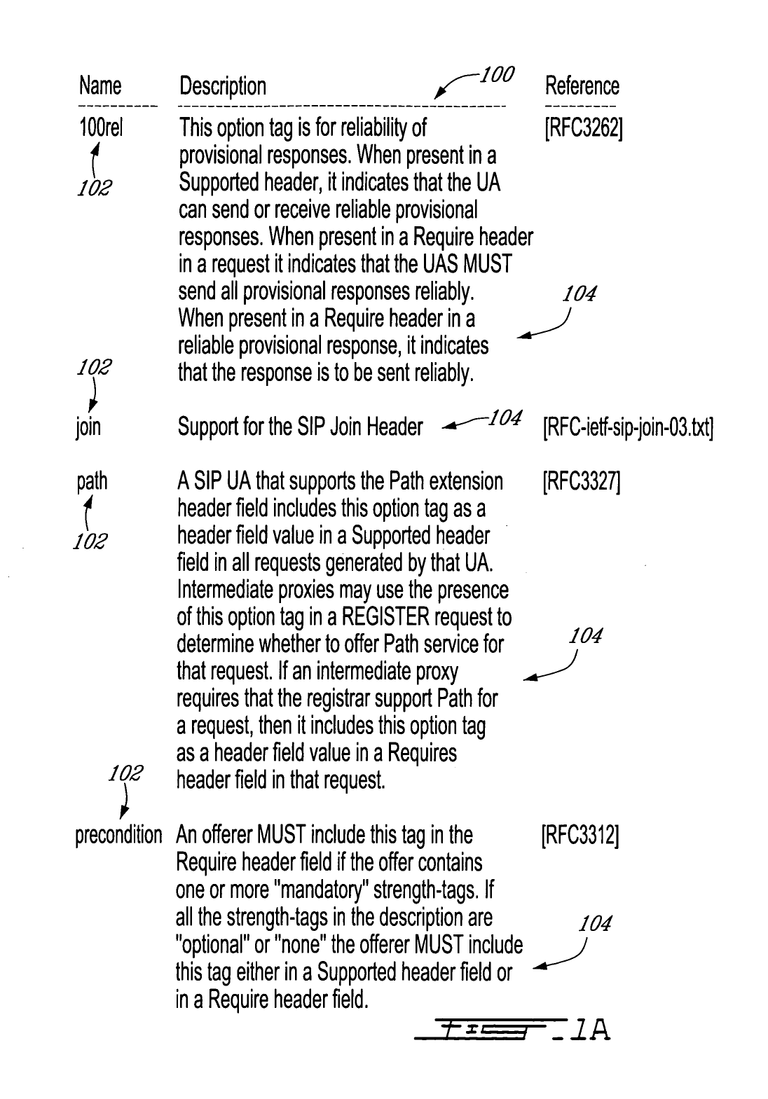

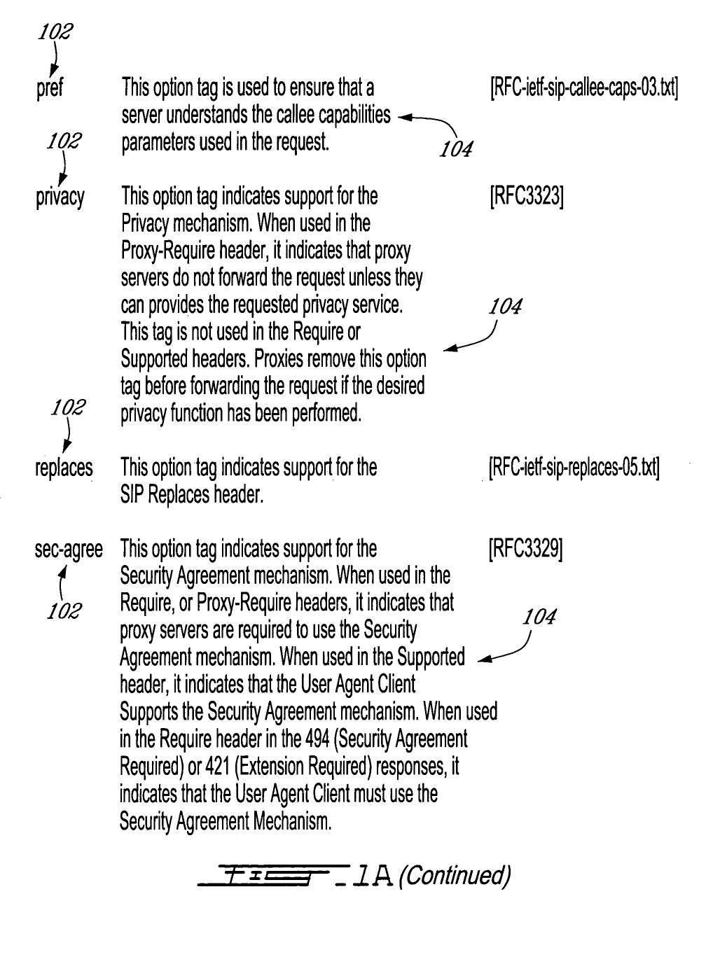

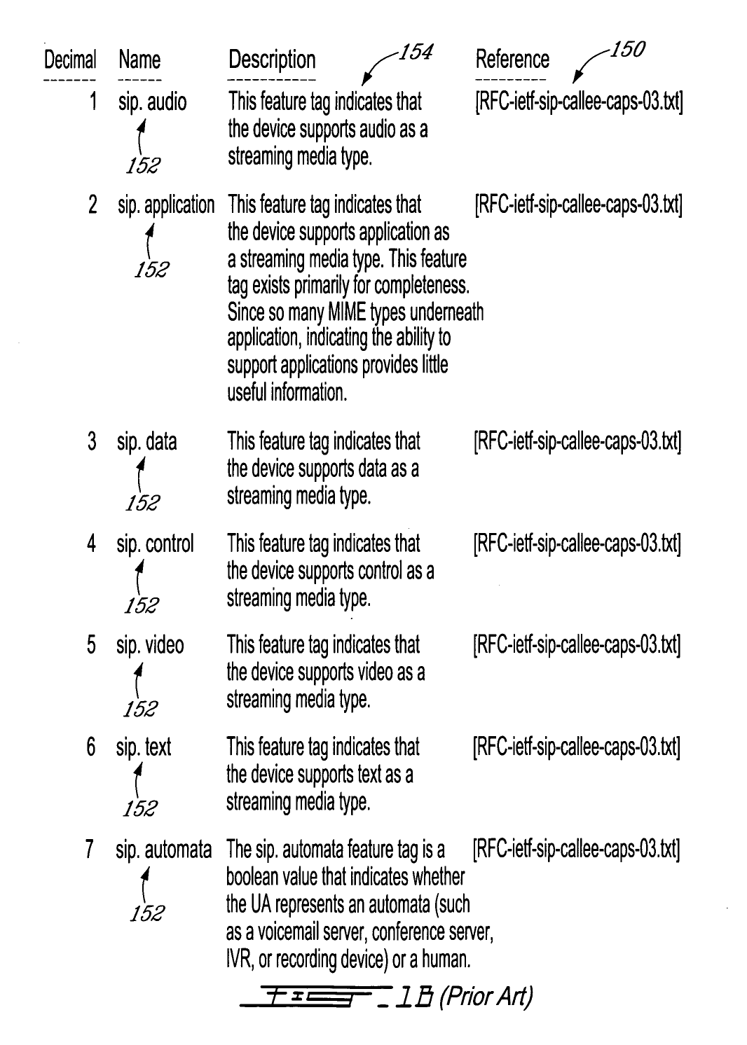

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

In the Session Initiation Protocol (SIP) messaging networks, certain originating end-points (e.g. caller terminals, servers, etc), or the nature of certain SIP messages require certain capabilities to be supported by the receiving end-points. For example, certain SIP messages addressed to services that are run on SIP application servers necessitate particular end-point capabilities to be supported by the service in order to be properly processed.

According to the preferred embodiment of the present invention, the functionality of a Session Initiation Protocol (SIP) container (also called herein a SIP engine) included in a SIP application server is extended with service logic that automatically interprets SIP end-point capabilities contained in incoming SIP messages and that determines if they match the capabilities of the SIP service run on the application server. In the affirmative, the SIP container invokes the SIP service and relays the message to the service for processing. Otherwise, a special treatment is applied (e.g. error message issued back to the sender, or a redirection of the message to a third party).

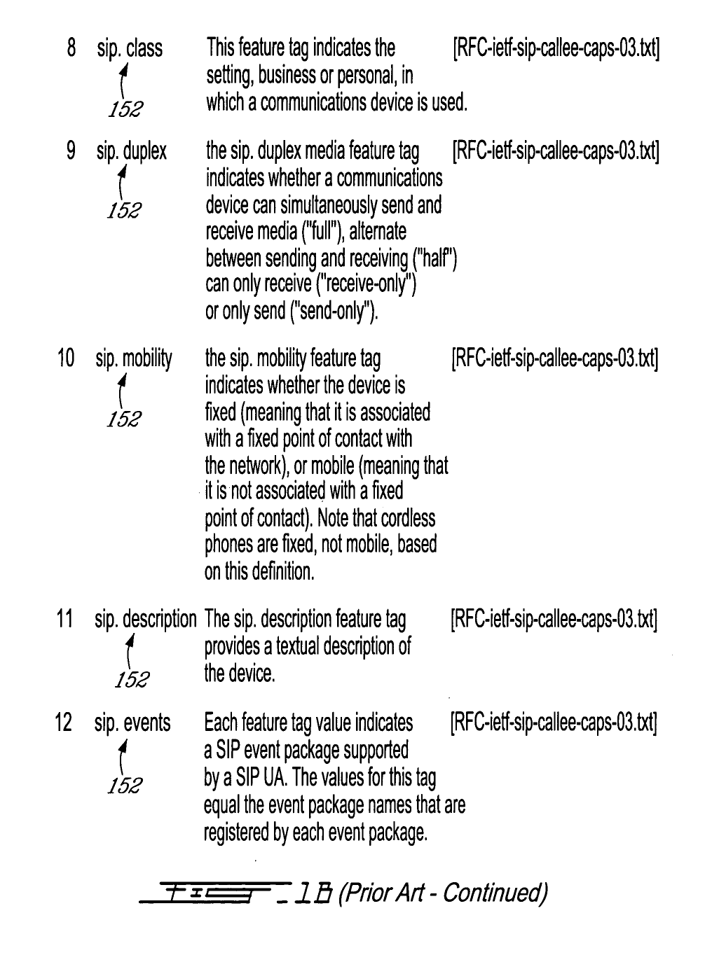

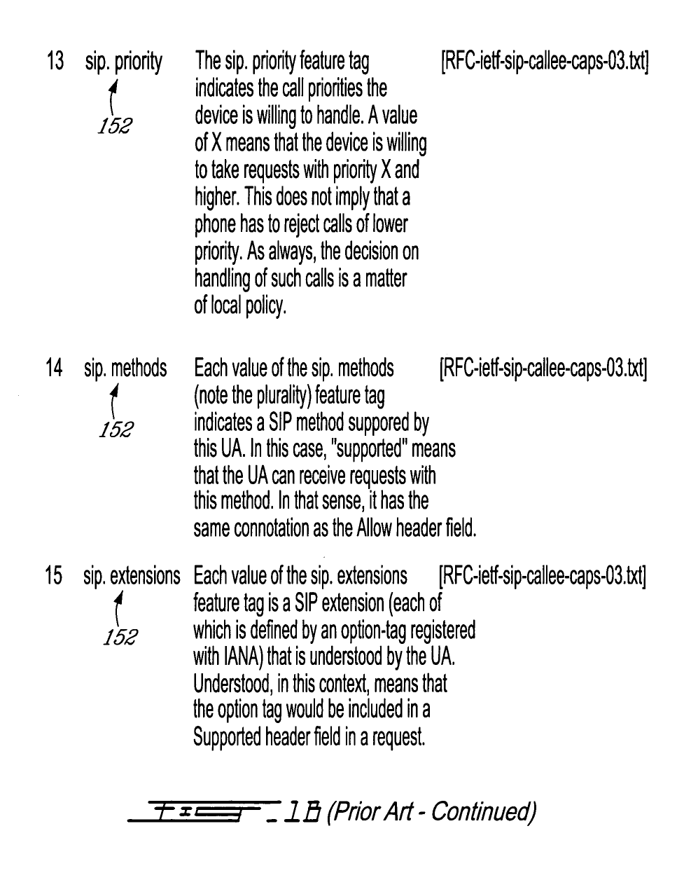

According to the present invention first, at deployment of a new SIP service on a SIP application server, the SIP container of the SIP application server analyses a deployment descriptor file associated with the given service (application). Typically, there is one deployment descriptor file for each service deployed on the application server, wherein that file contains the characteristics of the service, including the end-point capabilities supported and/or required by the service. According to the present invention, such end-point capabilities are expressed in terms of option tags and feature tags and a new tag is introduced in the deployment descriptor file of each service relative to the option or feature tag required or supported by the service. The name for these tags may be, for example:

<supported option tag> <value> </supported option tag>
and/or
<required option tag> <value> </required option tag> (as in the figure 2)
for option tags
and
<supported feature tag> <value> </supported feature tag>
for feature tags

The value in this tag indicates the particular option tag supported or required by the service for the proper processing of SIP messages, or respectively the feature tag supported by the SIP service for the proper processing of SIP messages. The same tag may appear multiple times if multiple option tags (or feature tags) are supported by the service. By analysing the deployment descriptor file of a SIP service, the SIP container reads the option tags and feature tags that are supported or required by the service. If no tag of a given type (e.g. no option tag) exists in the deployment descriptor of a given SIP service, it is assumed that there is no support in the SIP service for any option tags.

According to the invention, following the reading of the deployment descriptor file of a given service, that service is activated on the SIP server. During operation, upon receipt of an incoming SIP message destined to the service at the SIP application server, the SIP container of the SIP application server examines certain headers of the incoming SIP message in order to detects end-point capabilities, such as the option tags required and/or supported by the sender of the incoming SIP message, and/or the feature tags required by the said sender.

The following table indicates the type of SIP message headers will the SIP container inspect to determine the end-point capabilities contained in the message, along with the description of these headers, and the information stored therein.

| | | Type Of | |
|---|---|---|---|
| | | Capability | SIP |
| Message | | Contained | Container |
| Header | Header Description | Therein | Inspects? |
| Required | Option tag required by the sender end-point | Option | Yes |
| | from the receiver end-point (for the proper | tags | |
| | processing of the SIP message) | | |
| Proxy-Required | Option tag inserted in the request message by | | Yes |
| | the caller requiring proxy nodes to understand | | |
| | the included option tag | | |
| Supported | Option tag supported by the sender end-point | | Yes |
| Unsupported | Option tag unsupported by the sender end-point | | No |
| Accept-Contact | Feature tag required by the sender end-point | Feature | Yes |
| | from the receiver end-point (for the proper | tags | |
| | processing of the SIP message) | | |
| Reject Contact | Feature tag that the sender end-point requires | | Yes |
| | the receiver end-point not to support | | |
| Request- | Feature tag indicating required proxy behaviour | | Yes |
| Disposition | | | |

Upon receipt of a SIP message, the SIP container inspects the above-mentioned message headers to determine which end-point capabilities are required by the sender end-point from the destination end-point, or supported by the sender side. Then, the SIP container further determines whether or not the destination SIP end-point service's capabilities match the capabilities indicated in the message. In the affirmative, the SIP container invokes the service and forwards the SIP message to the proper SIP service for processing. Otherwise, the SIP container does not invoke the destination SIP service, and may issue either a error message, or relay the message to another destination.

The following table shows the manner in which the SIP container determines whether or not the destination SIP end-point service's capabilities match the capabilities indicated in the message.

| | Type Of | | |
|---|---|---|---|
| | Capability | SIP | |
| Message | Contained | Container | SIP Container determines that the |
| Header | Therein | Inspect? | service's . . . |
| Required | Option | Yes | <Supported Option tag> matches the “Required” |
| | tags | | option tag of the SIP message |
| Proxy-Required | | Yes | <Supported Option tag> matches the “Proxy- |
| | | | Required” option tag of the SIP message |
| Supported | | Yes | <Required Option tag> matches the “Supported” |
| | | | option tag of the SIP message |
| Accept-Contact | Feature | Yes | <Supported Feature tag> matches the “Accept- |
| | tags | | Contact” feature tag of the SIP message |
| Reject-Contact | | Yes | <Supported Feature tag> does not match the |
| | | | “Reject-Contact” feature tag of the SIP message |
| Request- | | Yes | <Supported Feature tag> matches the “Request- |
| Disposition | | | Disposition” feature tag of the SIP message |

Reference is now made to FIG. 2, which is an exemplary high-level block diagram of a SIP application server 200 according to the preferred embodiment of the present invention. Shown in FIG. 2 is the SIP application server 200, which may comprise a computer system running an Operating System (OS), the server 200 further comprising a SIP container 202, also called a SIP engine, that implements SIP Servlet API (SSA) methods and service logic 204 supporting SIP-based communications for the server 200. Further shown in FIG. 2, are two (2) SIP services 206 and 208, also called SIP applications, responsible for implementing particular services in the server 200. The SIP services 206 and 208 are connected to the SIP container 202, as shown, via proper communication links and/or interfaces. Each one of the SIP services 206 and 208 comprises a deployment descriptor file 210 and 212 respectively, which comprises information about the services' capabilities relative to the option tags and feature tags supported or required by each service. For example, the SIP service 206 comprises the deployment descriptor file 210 that includes the indications 214, 216, and 218 related to two option tags supported or required by the SIP service 206, as well as one feature tag supported by the service 206.

The deployment descriptor file 210 preferably also contains a set of mapping rules 219 (specified in SSA). These mapping rules 219 contain criteria indicating which messages the service wishes to receive. This can be indicated, for example, by specifying the message type (e.g. SIP INVITE, SIP REGISTER, etc), the Request URI (Uniform Resource Indicator), or using information from the message header (destination or sender identifier).

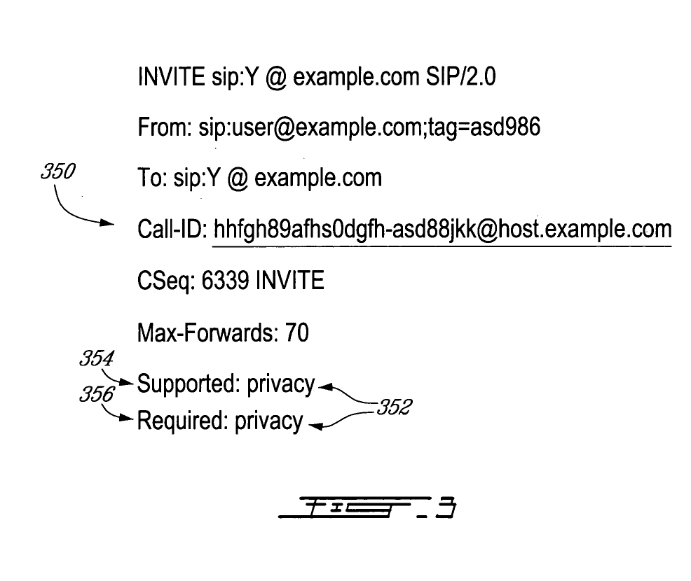

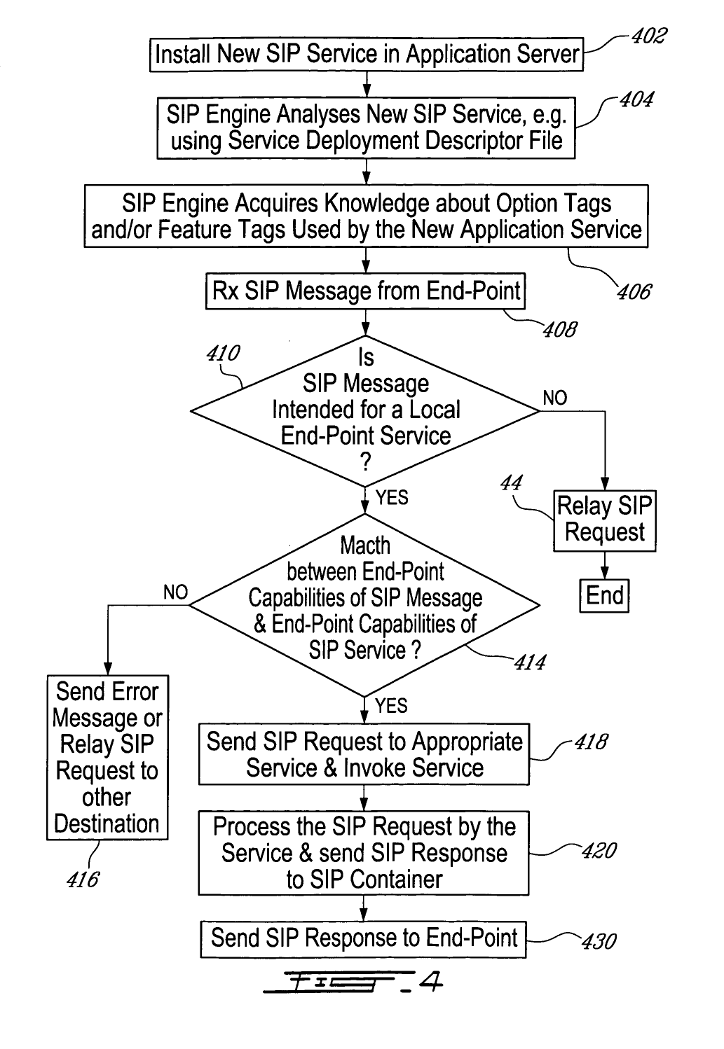

Reference is now made jointly to FIG. 2, previously described, and to FIG. 4, which is an exemplary flowchart diagram of a method according to the preferred embodiment of the present invention. In this method, first, in action 402, a new SIP service, such as for example the SIP service 206 is installed in the SIP application server 200. In action 404, the SIP container 202 analyzes the new SIP service 206 in order to determine which end-point capabilities, i.e. which option tags and/or feature tags, are supported or required by the service. Preferably, as shown in FIG. 2, the service 206 also comprises a deployment descriptor file 210 that stores information relative to its supported and/or required end-point capabilities (option tags and feature tags). In such a case, action 404 comprises analyzing by the SIP container 202 the deployment descriptor file 210 of the service 206 for determining the option tags and feature tags supported and/or required by to the SIP service 206. By analyzing the deployment descriptor file 210, the SIP engine 202 acquires knowledge about the option and feature tags used (supported or required) by the new application service 206, action 406.

During operation, in action 408, the SIP application server 200 may receive a SIP message 220 from an external end-point, such as for example a SIP INVITE or a SIP REQUEST message, wherein the SIP message 220 comprises a Uniform Resource Identifier (URI) 222 that identifies the destination end-point of the message 220, and also destination end-point capabilities 223 that are either required from the destination end-point of the message 220 for the proper processing of that message, or supported by the sending end-point of the message 220. Upon receipt of the message 220, the SIP container 202 of the application server 200 first determines in action 410 whether or not the incoming SIP message 220 is destined to a local end-point, i.e. to one of the local SIP services 206 or 208. This may comprising examining the Servlet Mapping rules acquired from each service 206 and 208 to determine if any of the services are interested in receiving the message 220. For example, the SIP Container 202 may examine the Servlet Mapping rules 219 acquired from the deployment descriptor file 210 of the service 206 for comparing the URI 222 of the message 220 with the URI identifying the service 206 that act as a SIP end-point. In the negative, i.e. if the incoming SIP message 220 does not map with any of the mapping rules of the services, it is concluded that it is not destined to the local service 206, and in such as case, for example, the servlet mapping rules of the next service (e.g. of the service 208) are further analyzed in an analogous manner to determine whether or not the SIP message is destined to that service. If not, the SIP message 220 is further relayed (proxied) from the server 200 to the proper end-point external to the SIP application server 200, action 412. Otherwise, if it is detected in action 410 that the SIP message 220 matches one or more of the mapping rules of the SIP container, such as for example matching one or more of the mapping rules 219 of the service 206, the SIP container 202 further acts in action 414 to determine whether or not the end-point capabilities 223 specified in the message 220 in the headers described hereinbefore match the capabilities 214, 216, and 218 of the SIP service 206. Such a determination 414 may be effectuated, for example, as shown in the above-mentioned table, which is reproduced hereinbelow, too.

| | Type Of | | |
|---|---|---|---|
| | Capability | SIP | |
| Message | Contained | Container | SIP Container determines that the |
| Header | Therein | Inspect? | service's . . . |
| Required | Option | Yes | <Supported Option tag> matches the “Required” |
| | tags | | option tag of the SIP message |
| Proxy-Required | | Yes | <Supported Option tag> matches the “Proxy- |
| | | | Required” option tag of the SIP message |
| Supported | | Yes | <Required Option tag> matches the “Supported” |
| | | | option tag of the SIP message |
| Accept-Contact | Feature | Yes | <Supported Feature tag> matches the “Accept- |
| | tags | | Contact” feature tag of the SIP message |
| Reject-Contact | | Yes | <Supported Feature tag> does not match the |
| | | | “Reject-Contact” feature tag of the SIP message |
| Request- | | Yes | <Supported Feature tag> matches the “Request- |
| Disposition | | | Disposition” feature tag of the SIP message |

If the SIP container 202 determines in action 414 that a match is not achieved, like for example when one or more of the required end-point capabilities 223 are not supported by the SIP service 206, then it issues an error message (not shown) to the originator of the message 220 or alternatively may further relay(proxy) the SIP message 220 to yet another (alternate) destination, action 416. Otherwise, if the SIP container 202 rather determines in action 414 that a match is achieved between the end-point capabilities 223 specified in message 220 and the one related to the SIP service 206, then it invokes the service 206 and sends the SIP message 220 to that service, action 418. In action 420, the SIP service 206 processes the SIP message 220 according to its internal set-up for providing the appropriate service, and then returns to the SIP container 202 a SIP response message 230, a new SIP request 230 or even a copy of the original request 230, modified or unmodified, action 420. Finally, in action 430, the SIP container 202 sends out the SIP request and/or response message 230, which may be destined to the originator of the SIP message 220, or to any other party as required by the processing of the incoming SIP message 220.

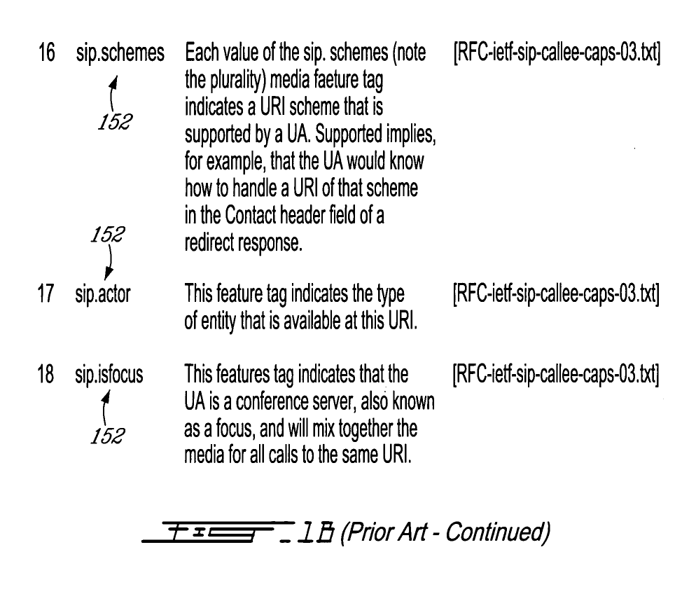

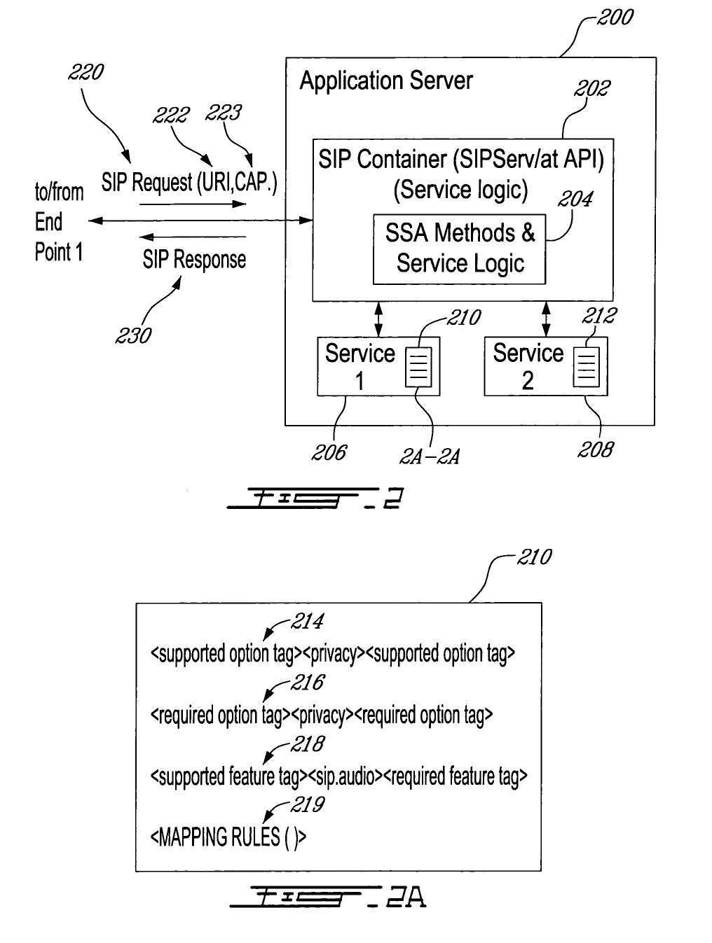

Reference is now made to FIG. 3, which is an exemplary representation of a SIP INVITE request message 350 comprising SIP end-point capabilities in the form of SIP option tags 352, which are included in a “Supported” header 354 as well as in a “Required” header 356. The INVITE message 350 is sent by a sender supporting the option tag “privacy” (shown in the “Supported” header 354) and who also wants the request to be routed to a terminating party that supports the same option tag “privacy” (shown in the “Required” option tag 356). That is, the “Required” field 356 of the SIP message header indicates that the SIP option “Privacy” is required from the destination end-point (the message receiver) for the message to be processed correctly, while the “Supported” field 354 of the SIP message header indicates that the SIP option “Privacy” is supported by the sender end-point. In the case of the message 350, it is these “Required” and “Supported” fields 354 and 356 of the SIP message header that the SIP container 202 inspects in previously described action 414.

Therefore, with the present invention it becomes possible to limit errors that occur when incoming SIP messages are processed by the SIP server, such as for example when they require the support of certain end-point capabilities in the form of option tags and/or feature tags, and when said end-point are not configured to support such capabilities.

Based upon the foregoing, it should now be apparent to those of ordinary skills in the art that the present invention provides an advantageous solution, which first verifies that the end-point capabilities specified in an incoming SIP message are matched by the ones supported and/or required by a given SIP service of the SP server, and only in the affirmative, the incoming SIP request message is forwarded to the service end-point. It should be realized upon reference hereto that the innovative teachings contained herein are not necessarily limited thereto and may be implemented advantageously with any applicable radio telecommunications standard that makes also use of SIP, or that supports SIP. Also, since the telecommunications industry recognises that according to the 3^{rd} Generation Partnership Project (3GPP), the interface between the above-mentioned type of application server and the SIP core network is based on the ISC interface (IP Multimedia Subsystem (IMS) Service Control interface), which is identical to SIP, all statements made herein with respect to the SIP protocol, including in the claims, should be understood as also encompassing ISC. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for processing an incoming Session Initiation Protocol (SIP) message, the method comprising the steps of:
a. receiving the incoming SIP message at a SIP application server, the incoming SIP message being destined to a SIP service;
b. detecting that the SIP service resides on the SIP application server;
c. determining end-point capabilities included in the incoming SIP message;
d. determining whether or not the end-point capabilities included in the incoming SIP message match end-point capabilities of the SIP service; and
e. upon determining that the end-point capabilities included in the incoming SIP message match the end-point capabilities of the SIP service, invoking the SIP service.

2. The method claimed in claim 1, wherein the end-point capabilities included in the incoming SIP message and the end-point capabilities of the SIP service comprise option tags.

3. The method claimed in claim 1, wherein the end-point capabilities included in the incoming SIP message and the end-point capabilities of the SIP service comprise feature tags.

4. The method claimed in claim 1, wherein step c. comprises the step of:
c.1 inspecting at least one of a “Required” header, a “Proxy Required” header, a “Supported” header, an “Accept-Contact” header, a Reject-Contact header and a “Request-Disposition” of the incoming SIP message; and
c.2 determining which end-point capabilities are indicated in the at least one of the “Required” header, the “Proxy Required” header, the “Supported” header, the “Accept-Contact” header, the Reject-Contact header and the “Request-Disposition” of the incoming SIP message.

5. The method claimed in claim 1, the method further comprising, prior to step a., the steps of:
f. installing the SIP service on the SIP application server; and
g. analysing by a SIP container of the SIP application server the SIP service and acquiring knowledge about the end-point capabilities of the SIP service.

6. The method claimed in claim 5, wherein step g. comprises analysing by the SIP container a deployment descriptor file associated with the SIP service and acquiring knowledge about end-point capabilities of the SIP service from the deployment descriptor file.

7. The method claimed in claim 1, wherein the SIP message is a SIP INVITE request message.

8. A Session Initiation Protocol (SIP) application server comprising:
a SIP container supporting SIP communications; and
a SIP service running on the SIP server;
wherein when an incoming SIP message is received at a SIP application server, the SIP container detects that the message is destined to the SIP service, determines end-point capabilities included in the incoming SIP message, further determines whether or not the end-point capabilities included in the incoming SIP message match end-point capabilities of the SIP service, and upon determining that the end-point capabilities included in the incoming SIP message match the end-point capabilities of the SIP service, invokes the SIP service.

9. The SIP application server claimed in claim 8, wherein the end-point capabilities included in the incoming SIP message and the end-point capabilities of the SIP service comprise option tags.

10. The SIP application server claimed in claim 8, wherein the end-point capabilities included in the incoming SIP message and the end-point capabilities of the SIP service comprise feature tags.

11. The SIP application server claimed in claim 8, wherein for determining the end-point capabilities included in the incoming SIP message, the SIP container acts to inspect at least one of a “Required” header, a “Proxy Required” header, a “Supported” header, an “Accept-Contact” header, a Reject-Contact header and a “Request-Disposition” of the incoming SIP message, and further acts to determine which end-point capabilities are indicated in the at least one of the “Required” header, the “Proxy Required” header, the “Supported” header, the “Accept-Contact” header, the Reject-Contact header and the “Request-Disposition” of the incoming SIP message.

12. The SIP application server claimed in claim 8, wherein the SIP service is first installed on the SIP application server, wherein the SIP container analyses the SIP service and acquires knowledge about the end-point capabilities of the SIP service.

13. The SIP application server claimed in claim 12, wherein SIP container analyses a deployment descriptor file associated with the SIP service and acquires knowledge about the end-point capabilities of the SIP service from the deployment descriptor file.

14. The SIP application server claimed in claim 8, wherein the SIP message is a SIP INVITE request message.
